(19) United States
(12) Patent Application Publication
(10) Pub. No.: US 2025/0344136 A1
(43) Pub. Date: Nov. 6, 2025

(54) SIB1 REQUEST

(71) Applicant: Samsung Electronics Co., Ltd., Suwon-si (KR)

(72) Inventors: Anil Agiwal, McKinney, TX (US); Kyeongin Jeong, Frisco, TX (US); Shiyang Leng, Little Elm, TX (US)

(21) Appl. No.: 19/186,466

(22) Filed: Apr. 22, 2025

Related U.S. Application Data
(60) Provisional application No. 63/641,594, filed on May 2, 2024.
(60) Provisional application No. 63/642,060, filed on May 3, 2024.

(51) Int. Cl. H04W 48/14; H04W 48/12

(52) U.S. Cl. CPC H04W 48/14; H04W 48/12

(57) ABSTRACT

A method of operating a user equipment (UE) includes receiving, from a first cell, a system information block 1 (SIB1) request configuration for a second cell, the SIB1 request configuration including at least one SIB1 request resource configuration, selecting, from the SIB1 request configuration, a SIB1 request resource configuration for requesting a SIB1 from the second cell, and initiating a random access (RA) procedure for requesting the SIB1. The method also includes, upon initiation of the RA procedure, selecting, based on at least one parameter in the SIB1 request configuration, an RA preamble from the SIB1 request resource configuration for requesting the SIB1 from the second cell, selecting, based on at least one parameter in the SIB1 request configuration, an RA channel (RACH) occasion for transmission of the RA preamble, and transmitting the RA preamble in the RACH occasion to request the SIB1 from the second cell.

### CROSS-REFERENCE TO RELATED APPLICATIONS AND CLAIM OF PRIORITY

This application claims priority under 35 U.S.C. § 119 (e) to U.S. Provisional Patent Application No. 63/641,594 filed on May 2, 2024, and U.S. Provisional Patent Application No. 63/642,060 filed on May 3, 2024. The above-identified provisional patent applications are hereby incorporated by reference in their entirety.

### TECHNICAL FIELD

This disclosure relates generally to wireless networks. More specifically, this disclosure relates to system information block 1 (SIB1) requests.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for SIB1 requests.

In one embodiment, a user equipment (UE) is provided. The UE includes a transceiver configured to receive, from a first cell, a system information block 1 (SIB1) request configuration for a second cell, the SIB1 request configuration including at least one SIB1 request resource configuration. The UE also includes a processor operably coupled to the transceiver. The processor is configured to select, from the SIB1 request configuration, a SIB1 request resource configuration for requesting a SIB1 from the second cell, and initiate a random access (RA) procedure for requesting the SIB1. The processor is also configured to, upon initiation of the RA procedure, select, based on at least one parameter in the SIB1 request configuration, an RA preamble from the SIB1 request resource configuration for requesting the SIB1 from the second cell, select, based on at least one parameter in the SIB1 request configuration, an RA channel (RACH) occasion for transmission of the RA preamble, and cause the transceiver to transmit the RA preamble in the RACH occasion to request the SIB1 from the second cell.

In another embodiment, a method of operating a UE is provided. The method includes receiving, from a first cell, a SIB1 request configuration for a second cell, the SIB1 request configuration including at least one SIB1 request resource configuration, selecting, from the SIB1 request configuration, a SIB1 request resource configuration for requesting a SIB1 from the second cell, and initiating a RA procedure for requesting the SIB1. The method also includes, upon initiation of the RA procedure, selecting, based on at least one parameter in the SIB1 request configuration, an RA preamble from the SIB1 request resource configuration for requesting the SIB1 from the second cell, selecting, based on at least one parameter in the SIB1 request configuration, a RACH occasion for transmission of the RA preamble, and transmitting the RA preamble in the RACH occasion to request the SIB1 from the second cell.

In yet another embodiment, a non-transitory computer readable medium embodying a computer program is provided. The computer program includes program code that, when executed by a processor of a device, causes the device to receive, from a first cell, a SIB1 request configuration for a second cell, the SIB1 request configuration including at least one SIB1 request resource configuration, select, from the SIB1 request configuration, a SIB1 request resource configuration for requesting a SIB1 from the second cell, and initiate a random access (RA) procedure for requesting the SIB1. The program code also causes the device to, upon initiation of the RA procedure, select, based on at least one parameter in the SIB1 request configuration, an RA preamble from the SIB1 request resource configuration for requesting the SIB1 from the second cell, select, based on at least one parameter in the SIB1 request configuration, a RACH occasion for transmission of the RA preamble, and transmit the RA preamble in the RACH occasion to request the SIB1 from the second cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for a SIB1 request according to embodiments of the present disclosure;

FIG. 5 illustrates an example procedure for acquiring an SI message according to embodiments of the present disclosure;

FIG. 6 illustrates another example procedure for acquiring an SI message according to embodiments of the present disclosure;

FIG. 7 illustrates another example procedure for acquiring an SI message according to embodiments of the present disclosure;

FIG. 8 illustrates another example procedure for acquiring an SI message according to embodiments of the present disclosure;

FIG. 9 illustrates another example procedure for acquiring an SI message according to embodiments of the present disclosure; and

FIG. 10 illustrates an example method for a SIB1 request according to embodiments of the present disclosure.

### DETAILED DESCRIPTION

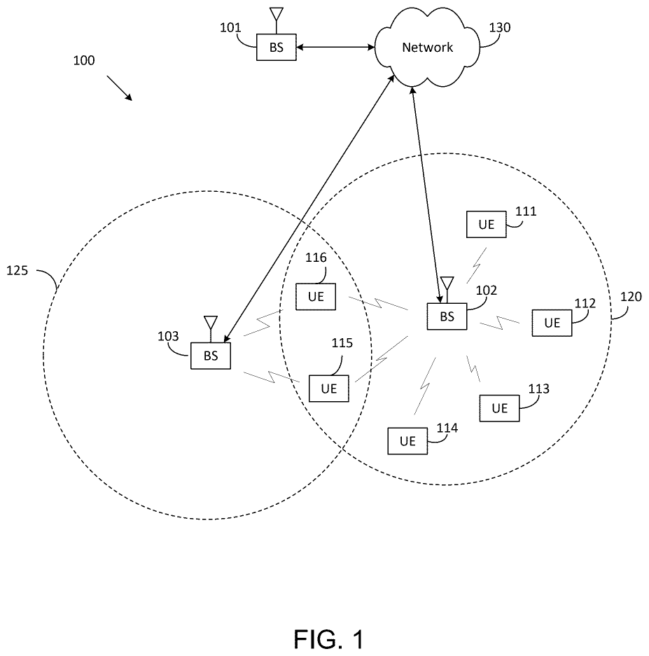

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for SIB1 requests. In certain embodiments, one or more of the gNBs 101-103 includes circuitry, programing, or a combination thereof, to support SIB1 requests in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

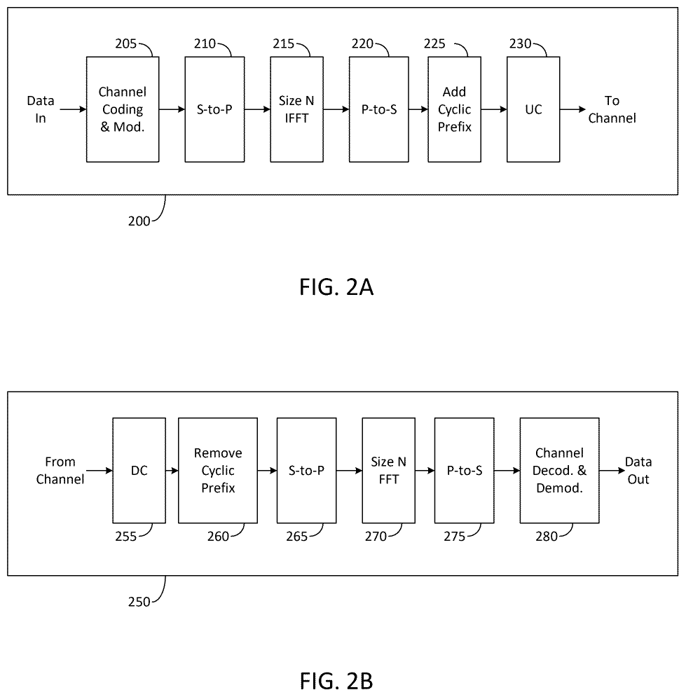

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support SIB1 requests as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

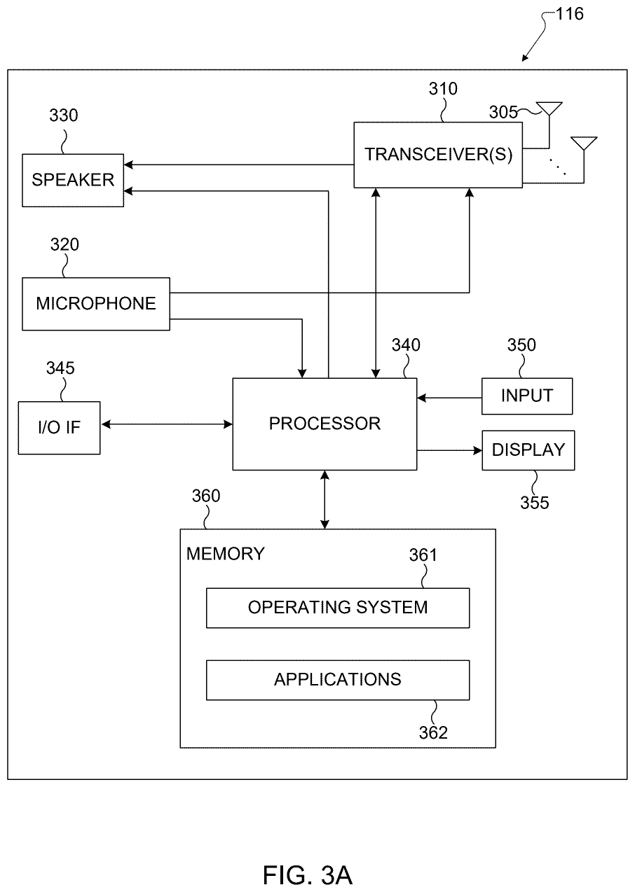

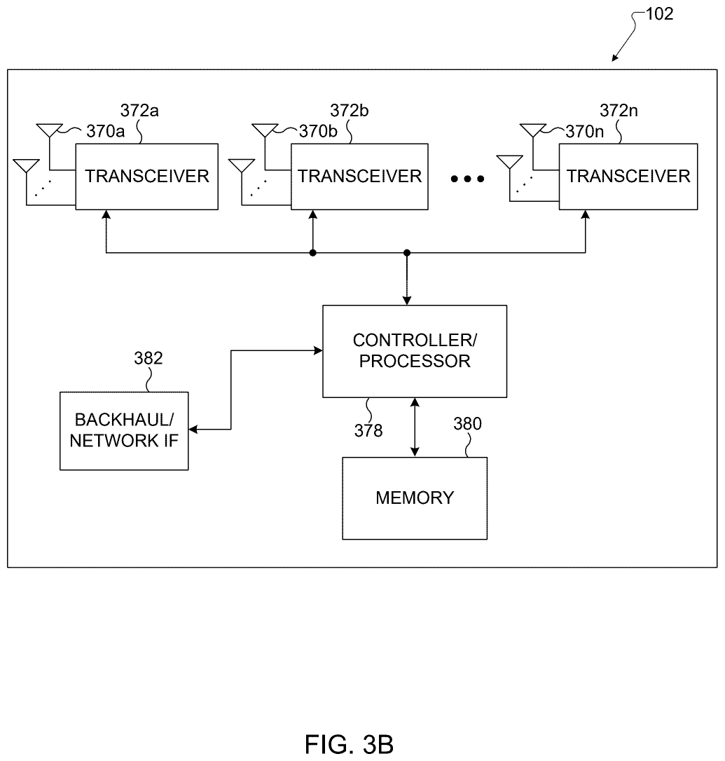

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for SIB1 requests as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support SIB1 requests as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or positioning SIBs (posSIBs) having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in an RRC_CONNECTED state. Several types of RA procedures are supported, such as contention based random access, and contention free random access. Each of these can be one of 2 step or 4 step random access.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SC). The number of slots in a radio frame and duration of slots depends on radio frame for each supported SCS is pre-defined in NR. Each CORESET configuration is associated with a list of Transmission configuration indicator (TCI) states. One DL RS ID (SSB or CSI RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is QCLed with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured). In the RRC IDLE and RRC INACTIVE states, the UE transmits/receives to/from the gNB on the initial Uplink BWP and initial DL BWP respectively. For a reduced capacity (RedCap) UE, the initial Uplink BWP and initial DL BWP for the RedCap UE can be optionally configured, which is used by the RedCap UE, if configured.

SIB1 is periodically transmitted in a cell by a gNB. The SIB1 transmission periodicity is 160 ms with repetition at every 20 ms within the 160 ms interval. Periodic transmissions lead to increased network energy consumption. On demand SIB1 transmission can enhance network energy savings wherein a cell can transmit SIB1 upon receiving a request from a UE instead of periodically broadcasting SIB1.

A SIB1 request may be triggered by a UE for several reasons, such as cell reselection, on demand SI acquisition, receiving an SI update, etc. Frequent requests from the same UE for SIB1 may reduce network energy savings. However, prohibiting SIB1 requests from the UE may delay SIB1 acquisition. Various embodiments of the present disclosure provide mechanisms for a UE to trigger a SIB1 request without reducing network energy savings, and avoiding delay in acquiring SIB1.

A cell supporting on demand SIB1 transmission may support several initial uplink BWPs, such as an initial uplink BWP of a NUL, an initial uplink BWP of a SUL, a RedCap specific initial uplink BWP of a NUL, etc. Various embodiments of the present disclosure provide mechanisms for a UE to determine on which BWP the UE should transmit a SIB1 request and receive an acknowledgement (ACK) for the SIB1 request when a cell supports on demand SIB1 transmission.

System information blocks (SIBs) other than the MIB and SIB1 can be periodically broadcast or provided on demand. These SIBs are transmitted in SI messages. Several SI messages can be supported in a cell, wherein a SIB is mapped to only one SI message and multiple SIBs can be mapped to a SI message. Each SI message is transmitted periodically or on demand in a SI window. A broadcast status bit for each SI message is transmitted in SIB1. The broadcast status bit indicates whether the SI message is broadcasting or notBroadcasting. The status notBroadcasting for an SI message means that if a UE needs any SIB mapped to this SI message, then the UE has to send an SI request to the gNB.

A change of si-BroadcastStatus does not result in system information change notifications from the network. The value of the indication is valid until the end of the broadcast control channel (BCCH) modification period when set to broadcasting. This means that if a UE needs a SIB, and the UE has not previously acquired the SIB1 in the current BCCH modification period, or it has acquired SIB1 but the si-BroadcastStatus in the SIB1 was set to notBroadcasting, the UE needs to acquire SIB1. The UE then checks the broadcast status bit in the acquired SIB1 to determine if the SI message of the SIB which the UE needs to acquire is set to broadcasting or notBroadcasting. If set to notBroadcasting, the UE needs to send an SI request for the SI message.

The cell may not be periodically broadcasting SIB1. This means that for checking the broadcast status bit, the UE needs to first send a request for SIB1. The UE then acquires SIB1 and checks the broadcast status bit and then sends another request for an SI message. This would lead to increased latency to acquire the SI message and also increases signaling overhead. Various embodiments of the present disclosure provide mechanisms for a UE to request an SI message with reduced latency and reduced signaling overhead.

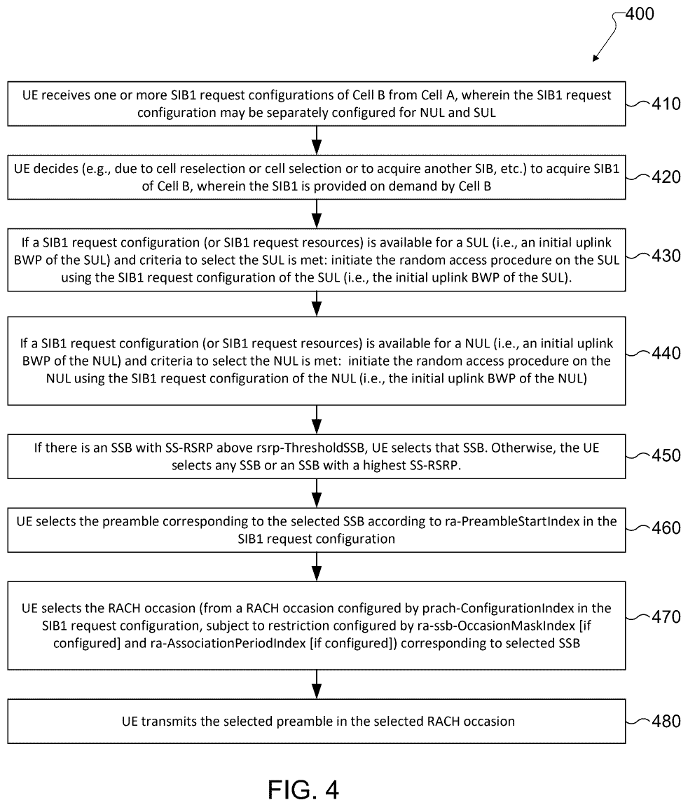

FIG. 4 illustrates an example procedure 400 for a SIB1 request according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for a SIB1 request could be used without departing from the scope of this disclosure.

In the example of FIG. 4, procedure 400 begins at operation 410. At operation 410, a UE (such as UE 116 of FIG. 1) acquires/receives one or more SIB1 request configurations of a cell “Cell B”. In some embodiments, the UE may acquire/receive the SIB1 request configuration(s) of Cell B from another cell “Cell A”. Alternately, in some embodiments, the UE may acquire/receive the SIB1 request configuration(s) of Cell B from Cell B. Alternately, in some embodiments, the UE may acquire the SIB1 request configuration(s) of Cell B via a pre-configuration (e.g., signaled via application layer signaling, non-access stratum [NAS] signaling, signaled via an over-the-top (OTT) server, etc.). Alternately, in some embodiments, the SIB1 request configuration of Cell B can be pre-defined. Alternately, in some embodiments, multiple SIB1 request configurations of Cell B can be pre-defined and an index of one the pre-defined configurations can be signaled (e.g., in the MIB/PBCH/synchronization signal of Cell B or in the system information of Cell A).

In some embodiments, the SIB1 request configuration(s) may include one or more of the following parameters:

FrequencyInfoUL. This parameter may include the following fields:
absoluteFrequencyPointA (Absolute frequency of the reference resource block [Common RB 0]. Its lowest subcarrier is also known as Point A. Note that the lower edge of the actual carrier is not defined by this field but rather in the scs-SpecificCarrierList.)
scs-SpecificCarrierList (A set of carriers for different subcarrier spacings [numerologies]. Defined in relation to Point A. The network configures a scs-SpecificCarrier at least for each numerology [SCS] that is used e.g., in a BWP.)
additionalSpectrumEmission (The additional spectrum emission requirements to be applied by the UE on this uplink.)
p-Max (Maximum transmit power allowed in this serving cell.)
frequencyShift7p5 khz (Enable the NR UL transmission with a 7.5 kHz shift to the LTE raster. If the field is absent, the frequency shift is disabled.)

rach-ConfigGeneric. This parameter may include the following fields:
prach-ConfigurationIndex (Index to an entry in a pre-defined table of PRACH configurations, each configuration indicates time domain location of PRACH occasions.)
msg1-FDM (The number of PRACH transmission occasions FDMed in one time instance.)
msg1-FrequencyStart (Offset of lowest PRACH transmission occasion in frequency domain with respective to PRB 0.)
zeroCorrelationZoneConfig
preambleReceivedTargetPower (Used to calculate PRACH transmission power.)
preambleTransMax (Max number of RA preamble transmission performed before declaring a failure.)
powerRampingStep (Power ramping steps for PRACH.)
ra-Response Window Msg2 (RAR) window length in number of slots

bwp-GenericParameters. This parameter may include the following fields:
locationAndBandwidth (Frequency domain location and bandwidth of this bandwidth part.)
subcarrierSpacing (Subcarrier spacing to be used in this BWP.)
cyclicPrefix (Indicates whether to use the extended cyclic prefix for this bandwidth part. If not set, the UE uses the normal cyclic prefix.)
ssb-PerRACH-Occasion (The number of SSBs for RACH occasion.)
prach-RootSequenceIndex
prach-SubcarrierSpacing (Subcarrier spacing of PRACH.)
n-TimingAdvanceOffset (The N_TA-Offset to be applied for random access.)
rsrp-ThresholdSSB (Threshold for SSB selection during SIB1 request procedure.)
rsrp-ThresholdSSB-SUL (Threshold for SUL/NUL selection during SIB1 request procedure.)
ra-ContentionResolutionTimer (this may be included if Msg3 based SIB1 request is supported)
ra-SearchSpace
controlResourceSetZero
searchSpaceZero
searchSpaceSIB1 (This may be absent, and UE uses searchSpaceZero and controlResourceSetZero for SIB1.)
commonSearchSpaceList (A list of additional common search spaces. If the network configures this field, it uses the SearchSpaceIds other than 0.)
commonControlResourceSet (An additional common control resource set.)
SIB1 request resources (no msg1 repetition). This parameter may include the following fields:
sib1-RequestPeriod
   Periodicity of the Sib1-Request configuration in number of association periods.
ra-PreambleStartIndex
   If N SSBs are associated with a RACH occasion, where N>=1, for the i-th SSB (i=0, . . . , N−1) the preamble with preamble index=ra-PreambleStartIndex+i is used for the SIB1 request. For N<1, the preamble with preamble index=ra-PreambleStartIndex is used for the SIB1 request.
ra-AssociationPeriodIndex
   Index of the association period in the si-RequestPeriod in which the UE can send the SI request for SI message(s) corresponding to this SI-RequestResources, using the preambles indicated by ra-PreambleStartIndex and RACH occasions indicated by ra-ssb-OccasionMaskIndex.
ra-ssb-OccasionMaskIndex (Indicates which of RACH occasions of an SSB configured by prach-ConfigurationIndex can be used for the SIB1 request.)

rsrp-ThresholdMsg1-RepetitionNum2, rsrp-ThresholdMsg1-RepetitionNum4, rsrp-ThresholdMsg1-RepetitionNum8: This parameter is a threshold used by the UE for determining whether to select resources for Msg1 repetition number 2, 4 or 8

SIB1 request resources (for two msg1 repetitions). This parameter may include the following field:
ra-PreambleStartIndex
   If N SSBs are associated with a RACH occasion, where N>=1, for the i-th SSB (i=0, . . . , N−1) the preamble with preamble index=ra-PreambleStartIndex+i is used for the SIB1 request. For N<1, the preamble with preamble index=ra-PreambleStartIndex is used for the SIB1 request.

SIB1 request resources (for four msg1 repetitions). This parameter may include the following field:
ra-PreambleStartIndex
   If N SSBs are associated with a RACH occasion, where N>=1, for the i-th SSB (i=0, . . . , N−1) the preamble with preamble index=ra-PreambleStartIndex+i is used for the SIB1 request. For N<1, the preamble with preamble index=ra-PreambleStartIndex is used for the SIB1 request.

SIB1 request resources (for eight msg1 repetitions). This parameter may include the following field:
ra-PreambleStartIndex
   If N SSBs are associated with a RACH occasion, where N>=1, for the i-th SSB (i=0, . . . , N−1) the preamble with preamble index=ra-PreambleStartIndex+i is used for the SIB1 request. For N<1, the preamble with preamble index=ra-PreambleStartIndex is used for the SIB1 request.

In some embodiments, rach-ConfigGeneric can be separately configured for various Msg1 repetitions (e.g., for 2/4/8 msg1 repetitions). In these embodiments, the UE applies the configuration according to the repetition number selected for the SIB1 request.

In some embodiments, rach-ConfigGeneric can be separately configured for no Msg1 repetition and Msg1 repetitions. In these embodiments, one rach-ConfigGeneric configuration is for no Msg1 repetition, and one rach-ConfigGeneric configuration is for all Msg1 repetitions. The UE applies the rach-ConfigGeneric configuration accordingly for the SIB1 request.

In some embodiments, a cell supporting on demand SIB1 transmission may support a supplementary uplink (SUL) and a normal uplink (NUL) carrier, and the SIB1 request configuration (or SIB1 request resources) can be separately configured for the SUL and NUL.

In some embodiments, a cell supporting on demand SIB1 transmission may support a SUL and an NUL carrier, and the SIB1 request configuration is common for the SUL and NUL.

In some embodiments, a cell supporting on demand SIB1 transmission may support a RedCap specific initial uplink BWP for the NUL, and the SIB1 request configuration (or SIB1 request resources) can be separately configured for this BWP.

In some embodiments, a cell supporting on demand SIB1 transmission may support a RedCap specific initial uplink BWP for the NUL, and the SIB1 request configuration is the same for the RedCap specific initial uplink BWP and an initial uplink BWP.

At operation 420, the UE decides (e.g., due to cell reselection, or cell selection, or to acquire another SIB, etc.) to acquire SIB1 of Cell B, wherein the SIB1 is provided on demand by Cell B.

At operation 430, for Cell B, if a SIB1 request configuration (or SIB1 request resources) is available/received for an SUL (i.e., an initial uplink BWP of the SUL) and criteria to select the SUL is met (if the cell supports an SUL carrier, and if the reference signal received power (RSRP) of the downlink pathloss reference is less than rsrp-ThresholdSSB-SUL, the UE selects the SUL carrier. Otherwise, the UE selects the NUL carrier.), the UE initiates a random access procedure on the SUL using the SIB1 request resources (PRACH preambles/resources)/SIB1 request configuration of the SUL (i.e., the initial uplink BWP of the SUL).

In some embodiments, at operation 440, for Cell B, if a SIB1 request configuration (or SIB1 request resources) is available/received for the NUL (i.e., an initial uplink BWP of an NUL) and criteria to select the NUL is met (if the cell supports an SUL carrier, and if the RSRP of the downlink pathloss reference is less than rsrp-ThresholdSSB-SUL, the UE selects the SUL carrier. Otherwise, the UE selects the NUL carrier. If the SIB1 request configuration or SIB1 request is supported only for NUL, the UE selects the NUL carrier), the UE initiates a random access procedure on the NUL using the SIB1 request resources (PRACH preambles/resources)/SIB1 request configuration of the NUL (i.e., the initial uplink BWP of the NUL).

Alternately, in some embodiments, at operation 440, for Cell B, if the UE is a RedCap UE and if a SIB1 request configuration (or SIB1 request resources) is available for a RedCap specific BWP of the NUL and criteria to select the NUL is met (if the cell supports an SUL carrier and if the RSRP of the downlink pathloss reference is less than rsrp-ThresholdSSB-SUL, the UE selects the SUL carrier. Otherwise, the UE selects the NUL carrier.), the UE triggers the lower layer to initiate a random access procedure on the NUL using the SIB1 request resources (PRACH preambles/resources)/SIB1 request configuration of the RedCap specific BWP of the NUL. Otherwise, if the UE is a RedCap UE and if a SIB1 request configuration (or SIB1 request resources) is not available for a RedCap specific BWP of the NUL and if a SIB1 request configuration (or SIB1 request resources) is available for a non-RedCap specific BWP of the NUL and criteria to select the NUL is met (if the cell supports an SUL carrier and if the RSRP of the downlink pathloss reference is less than rsrp-ThresholdSSB-SUL, the UE selects the SUL carrier. Otherwise, the UE selects the NUL carrier. If the SIB1 request configuration or SIB1 request is supported only for NUL, the UE selects the NUL carrier), the UE triggers the lower layer to initiate a random access procedure on the NUL using the SIB1 request resources (PRACH preambles/resources)/SIB1 request configuration of the non-RedCap specific BWP of the NUL.

At operation 450, if there is a synchronization signal block (SSB) (amongst the SSBs transmitted in Cell B; SSBs transmitted in Cell B can be signaled in the SIB1 request configuration) with an SS-RSRP above a threshold, the UE selects that SSB. Otherwise, the UE selects any SSB (amongst the SSBs transmitted in Cell B) or an SSB (amongst the SSBs transmitted in Cell B) with the highest SS-RSRP.

At operation 460, the UE selects the preamble corresponding to the selected SSB according to ra-PreambleStartIndex.

At operation 470, the UE selects a RACH occasion (from one or more RACH occasions configured by prach-ConfigurationIndex in the SIB1 request configuration, subject to a restriction configured by ra-ssb-OccasionMaskIndex [if configured] and ra-AssociationPeriodIndex [if configured]) corresponding to the selected SSB.

At operation 480, the UE transmits the selected preamble in the selected RACH occasion.

In some embodiments, after transmitting the preamble for the SIB1 request, the UE may monitor for a PDCCH addressed to a random access-radio network temporary identifier (RA-RNTI) in a random access window (ra-ResponseWindow). If a PDCCH addressed to the RA-RNTI is received and a transport block (TB) scheduled by this PDCCH is successfully decoded and the TB includes a MAC subPDU with RAPID only, wherein the RAPID is the identity of the RACH preamble transmitted by UE, the UE may consider that an ACK for the SIB1 request is successfully received. Upon receiving the ACK for the SIB1 request, the UE may monitor a PDCCH addressed to a SI-RNTI in PDCCH monitoring occasions configured by searchSpaceSIB1 or SearchSpace 0 (received in the SIB1 request configuration) to receive SIB1. In some embodiments, in response to a SIB1 request, the network may indicate that the network does not intend to transmit SIB1 and/or may indicate for the UE to bar this cell or reselect another cell.
If the RAR window expires and an ACK for the SIB1 request is not received, the UE may retransmit the preamble for the SIB1 request.
If the UE has transmitted the preamble for the SIB1 request preamble TransMax times and has not received an ACK for the SIB1 request (i.e., a random-access procedure for the SIB1 request fails), the UE may bar the cell.

Alternately, in some embodiments, after transmitting the preamble for the SIB1 request, the UE may monitor a PDCCH addressed to an SI-RNTI in PDCCH monitoring occasions configured by searchSpaceSIB1 or SearchSpace 0 to receive the SIB1. In some embodiments, the PDCCH monitoring occasions configured by searchSpaceSIB1 or SearchSpace 0 may be monitored in a transmission period which occurs at least at an offset from an end of (a slot/subframe/frame/symbol/transmission period of) the preamble transmission. The transmission period can be 20 ms, 160 ms or any other value pre-defined or configured by the network. In some embodiments, the PDCCH monitoring occasions configured by searchSpaceSIB1 or SearchSpace 0 may be monitored in a transmission window which occurs at least at an offset from the end of (a slot/subframe/frame/symbol/transmission period of) the preamble transmission. The transmission window can be 20 ms, 160 ms or any other value pre-defined or configured by the network. The offset can be pre-defined or configured by the network. The offset can be zero or not applied.

Although FIG. 4 illustrates one example procedure 400 for a SIB1 request, various changes may be made to FIG. 4. For example, while shown as a series of operations, various operations in FIG. 4 could overlap, occur in parallel, occur in a different order, occur any number of times, be omitted, or replaced by other operations.

In some embodiments, upon transmitting a SIB1 request in a cell, a UE may start a prohibit timer. This timer is stopped when the UE performs cell reselection or enters an RRC_CONNECTED state. The timer value can be configured by the network (e.g., in a SIB1 request configuration). If the UE decides to acquire a SIB1 by sending a SIB1 request and the prohibit timer is not running, the UE sends the SIB1 request. Otherwise, the UE waits for the timer to expire before sending SIB1 request.

In some embodiments the prohibit timer may or may not be applied for some triggers for a SIB1 request. For example:

In some embodiments, the prohibit timer may not be applied for the case where SIB1 acquisition is for cell (re) selection. In this case the UE does not need to check whether the prohibit timer is running before sending the SIB1 request. The UE can send the SIB1 request irrespective of whether the prohibit timer is running.

In some embodiments, the prohibit timer may not be applied for the case where SIB1 acquisition is for an emergency call. In this case the UE does not need to check whether the prohibit timer is running before sending the SIB1 request. The UE can send the SIB1 request irrespective of whether the prohibit timer is running.

In some embodiments, the prohibit timer may not be applied for the case where SIB1 acquisition is for connection setup/resume due to availability of UL data, wherein the UL data volume is greater than a threshold. In this case the UE does not need to check whether the prohibit timer is running before sending the SIB1 request. The UE can send the SIB1 request irrespective of whether the prohibit timer is running.

In some embodiments, the prohibit timer may be applied for the case where SIB1 acquisition is for connection setup/resume due to availability of UL data, wherein the UL data volume is less than a threshold. In this case the UE checks whether the prohibit timer is running before sending the SIB1 request. If the prohibit timer is running, the UE cannot send the SIB1 request. If the prohibit timer is not running, the UE can send the SIB1 request.

In some embodiments, the prohibit timer may be applied for the case where SIB1 acquisition is for other SI (OSI) acquisition. In this case the UE checks whether the prohibit timer is running before sending the SIB1 request. If the prohibit timer is running, the UE cannot send the SIB1 request. If the prohibit timer is not running, the UE can send the SIB1 request.

In some embodiments, if SIB1 request resources for 8 Msg1 repetitions are configured and the RSRP of the downlink pathloss reference is less than rsrp-ThresholdMsg1-RepetitionNum8, criteria to apply Msg1 repetition for the SIB1 request is considered met and the Msg1 repetition number applicable is 8. Otherwise, if SIB1 request resources for 4 Msg1 repetitions are configured and the RSRP of the downlink pathloss reference is less than rsrp-ThresholdMsg1-RepetitionNum4, criteria to apply Msg1 repetition for the SIB1 request is considered met and the Msg1 repetition number applicable is 4. Otherwise, if SIB1 request resources for 2 Msg1 repetitions are configured and the RSRP of the downlink pathloss reference is less than rsrp-ThresholdMsg1-RepetitionNum2, criteria to apply Msg1 repetition for the SIB1 request is considered met and the Msg1 repetition number applicable is 2. In some embodiments, if SIB1 request resources for N Msg1 repetitions are configured and the RSRP of the downlink pathloss reference is less than rsrp-ThresholdMsg1-RepetitionNumN, criteria to apply Msg1 repetition for the SIB1 request is considered met and the Msg1 repetition number applicable is N. N is an integer greater than 1.

In some embodiments, if a SIB1 request configuration (or SIB1 request resources) for Msg1 repetitions is available for a SUL (i.e., an initial uplink BWP of the SUL) and criteria to select the SUL is met and if criteria to apply Msg1 repetition (as explained above) for the SUL is met, the UE may initiate the random access procedure on the SUL using the SIB1 request resources (PRACH preambles/resources)/SIB1 request configuration of the SUL (i.e., the initial uplink BWP of the SUL) associated with the applicable repetition number. Otherwise, if a SIB1 request configuration (or SIB1 request resources) for no Msg1 repetitions is available for the SUL (i.e., the initial uplink BWP of SUL) and criteria to select the SUL is met, the UE may initiate the random access procedure on the SUL using the SIB1 request resources (PRACH preambles/resources)/SIB1 request configuration of the SUL (i.e., the initial uplink BWP of the SUL) not associated with a repetition number.

In some embodiments, if a SIB1 request configuration (or SIB1 request resources) for Msg1 repetitions is available for the NUL (i.e., an initial uplink BWP the NUL) and criteria to select the NUL is met and if criteria to apply Msg1 repetitions (as explained above) for the NUL is met, the UE may initiate the random access procedure on the NUL using the SIB1 request resources (PRACH preambles/resources)/SIB1 request configuration of the NUL (i.e., the initial uplink BWP of the NUL) associated with the applicable repetition number. Otherwise, if a SIB1 request configuration (or SIB1 request resources) for no Msg1 repetitions is available for the SUL (i.e., the initial uplink BWP of the NUL) and criteria to select the NUL is met, the UE may initiate the random access procedure on the NUL using the SIB1 request resources (PRACH preambles/resources)/SIB1 request configuration of the NUL (i.e., the initial uplink BWP of the NUL) not associated with a repetition number.

Alternately, in some embodiments, if the UE is a RedCap UE and if a SIB1 request configuration (or SIB1 request resources) for Msg1 repetitions is available for a RedCap specific BWP of the NUL and criteria to select the NUL is met and if criteria to apply Msg1 repetitions (as explained above) for the NUL is met, the UE may trigger the lower layer to initiate the random access procedure on the NUL using the SIB1 request resources (PRACH preambles/resources)/SIB1 request configuration of the RedCap specific BWP of the NUL associated with the applicable repetition number. Otherwise, if the UE is a RedCap UE and if a SIB1 request configuration (or SIB1 request resources) for no Msg1 repetitions is available for the RedCap specific BWP of the NUL and criteria to select the NUL is met, the UE may trigger the lower layer to initiate the random access procedure on the NUL using the SIB1 request resources (PRACH preambles/resources)/SIB1 request configuration of the RedCap specific BWP of the NUL not associated with any repetition number.

In some embodiments, if there is an SSB (amongst the SSBs transmitted in the Cell B) with an SS-RSRP above a threshold, the UE may select that SSB. Otherwise, the UE may select any SSB (amongst the SSBs transmitted in the Cell B) or an SSB (amongst the SSBs transmitted in the Cell B) with a highest SS-RSRP.

In some embodiments, the UE may select a preamble corresponding to the selected SSB according to ra-PreambleStartIndex.

In some embodiments, the UE may select a RACH occasion (from one or more RACH occasions configured by prach-ConfigurationIndex in the SIB1 request configuration associated with the repetition number) corresponding to the selected SSB.

In some embodiments, the UE may transmit the selected preamble N (2/4/8/1) times in the selected RACH occasion.

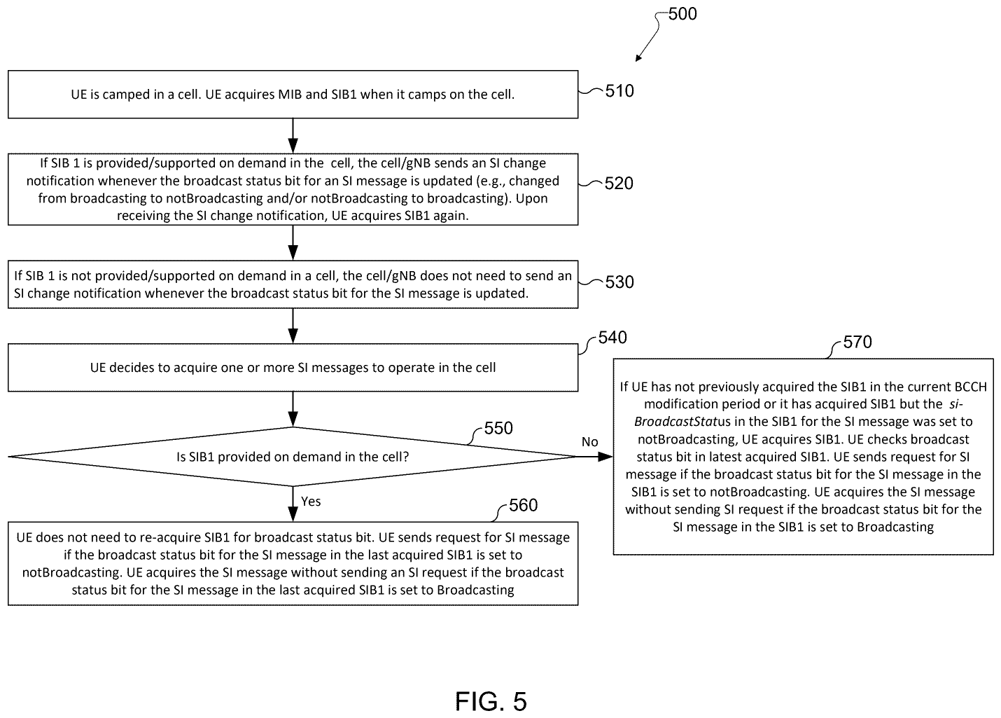

FIG. 5 illustrates an example procedure 500 for acquiring an SI message according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 5, procedure 500 begins at operation 510. At operation 510, a UE (such as UE 116 of FIG. 1) is camped in a cell. The UE acquires the MIB and SIB1 of the cell when the UE camps on the cell.

The cell may provide/support on demand SIB1 transmission. In some embodiments, at operation 520, if SIB1 is provided/supported (or currently being provided) on demand in the cell (or in the active DL BWP of the cell), the cell/a gNB sends an SI change notification whenever a broadcast status bit for an SI message is updated (e.g., changed from broadcasting to notBroadcasting and/or notBroadcasting to broadcasting). Upon receiving this SI change notification, the UE acquires SIB1 again. Alternately, in some embodiments, at operation 520, if SIB1 is provided/supported (or currently being provided) on demand in the cell (or in the active DL BWP of the cell), the cell/a gNB sends SIB1 in dedicated RRC message whenever SIB1 is updated including the case where a broadcast status bit for an SI message is updated (e.g., changed from broadcasting to notBroadcasting and/or notBroadcasting to broadcasting).

At operation 530, if SIB1 is not provided/supported (or currently not being provided) on demand in the cell, the cell/gNB does not need to send an SI change notification whenever the broadcast status bit for the SI message is updated.

At operation 540, the UE may decide to acquire one or more SI messages (or SIBs other than SIB1) to operate in the cell.

At operation 550, if SIB1 is provided/supported (or currently being provided) on demand, procedure 500 proceeds to operation 560. Otherwise, if SIB1 is not provided/supported (or currently not being provided) on demand, procedure 500 proceeds to operation 570.

At operation 560, the UE does not need to re-acquire SIB1 for the broadcast status bit. The UE sends a request for the SI message (or SIB other than SIB1) if the broadcast status bit for the SI message (or SIB other than SIB1) in the last acquired SIB1 is set to notBroadcasting. The UE acquires the SI message (or SIB other than SIB1) without sending an SI request if the broadcast status bit for the SI message (or SIB other than SIB1) in the last acquired SIB1 is set to Broadcasting. Alternately, in some embodiments, the UE sends a request for the SI message (or SIB other than SIB1) without checking the broadcast status bit for the SI message (or SIB other than SIB1).

At operation 570, if the UE has not previously acquired the SIB1 in the current BCCH modification period or the UE has acquired SIB1 but the si-BroadcastStatus in the SIB1 for the SI message (or SIB other than SIB1) was set to notBroadcasting, the UE acquires SIB1. The UE checks the broadcast status bit in the latest acquired SIB1. The UE sends a request for an SI message (or SIB other than SIB1) if the broadcast status bit for the SI message (or SIB other than SIB1) in the SIB1 is set to notBroadcasting. The UE acquires the SI message (or SIB other than SIB1) without sending an SI request if the broadcast status bit for the SI message (or SIB other than SIB1) in the SIB1 is set to Broadcasting.

Although FIG. 5 illustrates one example procedure 500 for acquiring an SI message, various changes may be made to FIG. 5. For example, while shown as a series of operations, various operations in FIG. 5 could overlap, occur in parallel, occur in a different order, occur any number of times, be omitted, or replaced by other operations.

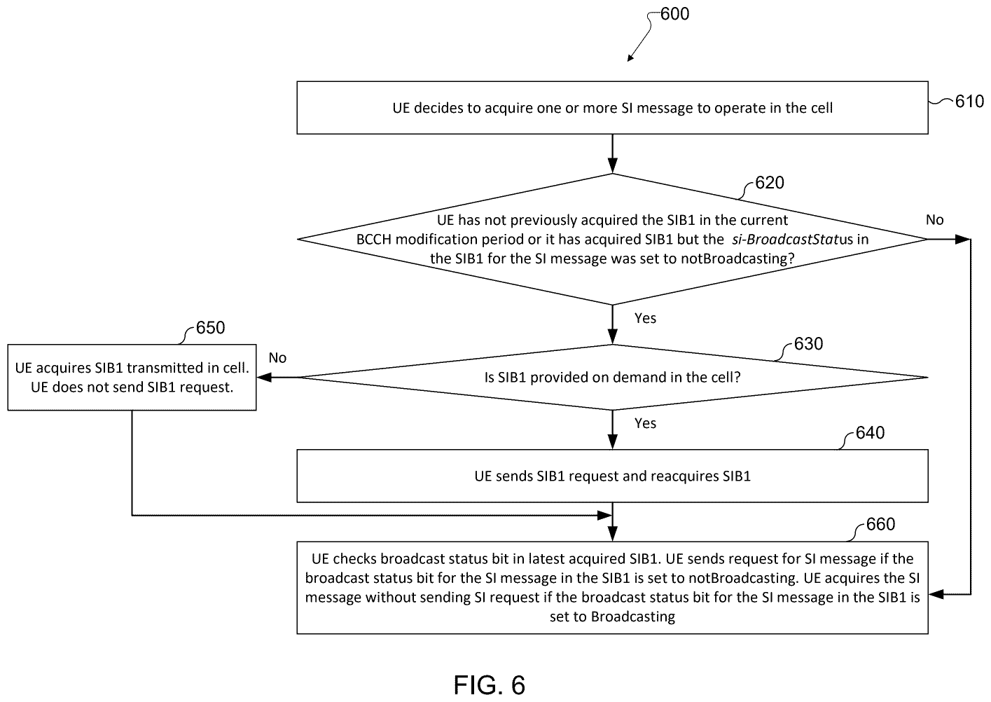

FIG. 6 illustrates another example procedure 600 for acquiring an SI message according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 6, a UE (such as UE 116 of FIG. 1) is camped in a cell. The UE acquires the MIB and SIB1 of the cell when the UE camps on the cell. The UE may acquire the MIB and SIB1 again whenever an SI change notification is received from a gNB of the cell.

Procedure 600 begins at operation 610. At operation 610, the UE may decide to acquire one or more SI messages (or SIBs other than SIB1) to operate in the cell.

At operation 620, if UE has not previously acquired SIB1 in the current BCCH modification period or the UE has acquired SIB1 but the si-BroadcastStatus in the SIB1 for the SI message (or SIB other than SIB1) was set to notBroadcasting, procedure 600 proceeds to operation 630. Otherwise, procedure 600 proceeds to operation 660.

At operation 630, if SIB1 is provided/supported (or currently being provided) on demand, procedure 600 proceeds to operation 640. Otherwise, procedure 600 proceeds to operation 650.

At operation 640, the UE acquires SIB1 by sending a SIB1 request (e.g., by initiating a random access procedure for the SIB1 request or by sending a dedicated RRC message for the SIB1 request).

At operation 650, the UE acquires SIB1 when SIB1 is transmitted in the cell. The UE does not send a SIB1 request.

At operation 660, the UE checks the broadcast status bit in the latest acquired SIB1. The UE sends a request for an SI message (or SIB other than SIB1) if the broadcast status bit for the SI message (or SIB other than SIB1) in the SIB1 is set to notBroadcasting. The UE acquires the SI message (or SIB other than SIB1) without sending an SI request if the broadcast status bit for the SI message (or SIB other than SIB1) in the SIB1 is set to Broadcasting.

Although FIG. 6 illustrates one example procedure 600 for acquiring an SI message, various changes may be made to FIG. 6. For example, while shown as a series of operations, various operations in FIG. 6 could overlap, occur in parallel, occur in a different order, occur any number of times, be omitted, or replaced by other operations.

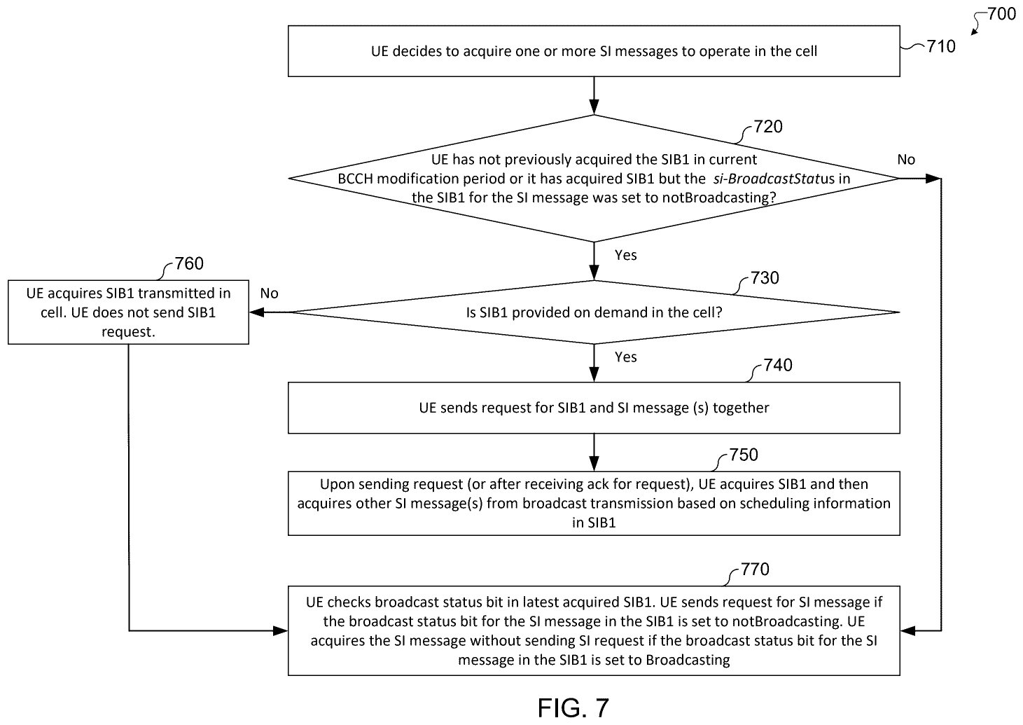

FIG. 7 illustrates another example procedure 700 for acquiring an SI message according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 7, a UE (such as UE 116 of FIG. 1) is camped in a cell. The UE acquires the MIB and SIB1 of the cell when the UE camps on the cell. The UE may acquire the MIB and SIB1 again whenever an SI change notification is received from a gNB of the cell.

Procedure 700 begins at operation 710. At operation 710, the UE may decide to acquire one or more SI messages (or SIBs other than SIB1) to operate in the cell.

At operation 720, if the UE has not previously acquired SIB1 in the current BCCH modification period or the UE has acquired SIB1 but the si-BroadcastStatus in the SIB1 for the SI message (or SIB other than SIB1) was set to notBroadcasting, procedure 700 proceeds to operation 730. Otherwise, procedure 700 proceeds to operation 770.

At operation 730, if SIB1 is provided/supported (or currently being provided) on demand, procedure 700 proceeds to operation 740. Otherwise, procedure 700 proceeds to operation 760.

At operation 740, the UE can send a request for SIB1 and SI message(s) together.

In some embodiments, the request sent at operation 740 may indicate SIB1 and OSI (i.e., other system information [SI message(s)]). SIB1 request resources (preambles/RACH occasions) for ‘SIB1+OSI’ are used for sending the request. The request does not indicate which SI message (or SIB other than SIB1) is requested. The configuration for the SIB1 request includes SIB1 request resources (preambles/RACH occasions) for SIB1 only, and SIB1 request resources (preambles/RACH occasions) for ‘SIB1+OSI’. In one embodiment, upon receiving the request, a gNB of the cell can broadcast all OSIs (all SI messages/SIBs). Alternately, in some embodiments, the gNB of the cell can send an UL grant in response to the request (e.g., together with a SIB1 request ACK). The UE can then transmit the OSI request (i.e., the request for an SI message [or SIB other than SIB1]) in this grant indicating which SI messages (or SIBs other than SIB1) are used by the UE to operate in the cell.

In some embodiments, the request sent at operation 740 may indicate SIB1 and specific OSI(s)/SI message(s). In these embodiments, the network broadcasts only the indicated OSI(s)/SI message(s)/SIBs upon receiving the request. The configuration for the SIB1 request includes SIB1 request resources (preambles/RACH occasions) for SIB1 only, and for each SI message (or SIB other than SIB1) provided on demand, SIB1 request resources (preambles/RACH occasions) for ‘SIB1+SI message (or SIB other than SIB1)’.

At operation 750, upon sending the request (or after receiving an ACK for the request), the UE acquires SIB1 and then acquires other SI message(s) (or SIBs other than SIB1) from a broadcast transmission based on scheduling information in SIB1.

At operation 760, the UE acquires SIB1 when SIB1 is transmitted in the cell. The UE does not send a SIB1 request.

At operation 770, the UE checks the broadcast status bit in latest acquired SIB1. The UE sends a request for an SI message (or SIB other than SIB1) if the broadcast status bit for the SI message (or SIB other than SIB1) in the SIB1 is set to notBroadcasting. The UE acquires the SI message (or SIB other than SIB1) without sending an SI request if the broadcast status bit for the SI message (or SIB other than SIB1) in the SIB1 is set to Broadcasting.

Although FIG. 7 illustrates one example procedure 700 for acquiring an SI message, various changes may be made to FIG. 7. For example, while shown as a series of operations, various operations in FIG. 7 could overlap, occur in parallel, occur in a different order, occur any number of times, be omitted, or replaced by other operations.

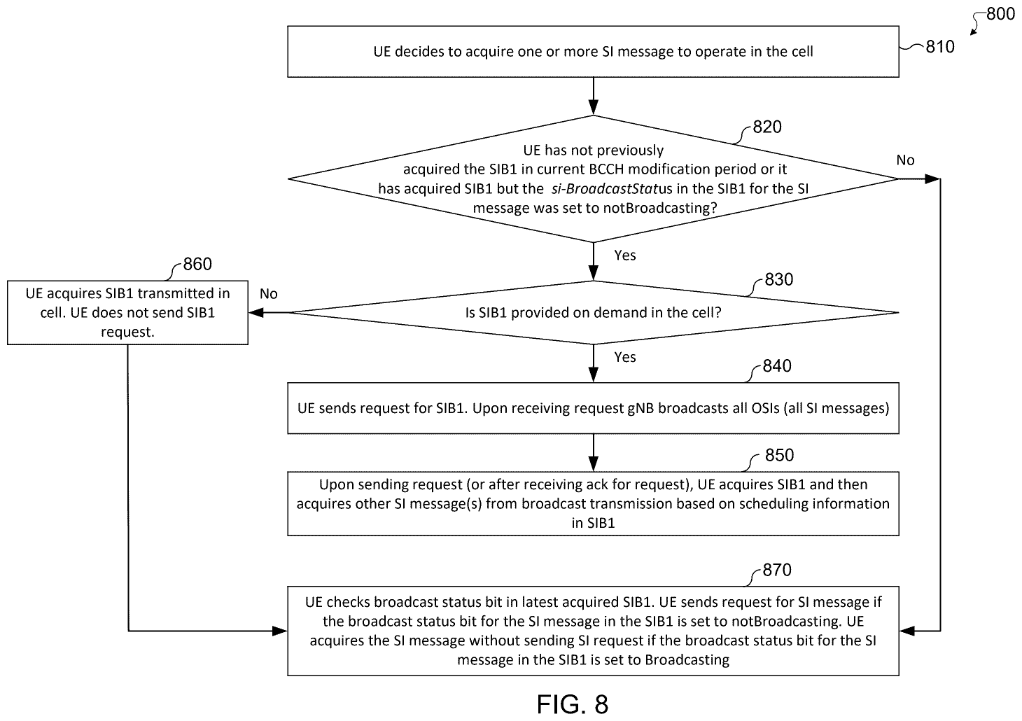

FIG. 8 illustrates another example procedure 800 for acquiring an SI message according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 8, a UE (such as UE 116 of FIG. 1) is camped in a cell. The UE acquires the MIB and SIB1 of the cell when the UE camps on the cell. The UE may acquire the MIB and SIB1 again whenever an SI change notification is received from a gNB of the cell.

Procedure 800 begins at operation 810. At operation 810, the UE may decide to acquire one or more SI messages (or SIBs other than SIB1) to operate in the cell.

At operation 820, if the UE has not previously acquired the SIB1 in the current BCCH modification period or the UE has acquired SIB1 but the si-BroadcastStatus in the SIB1 for the SI message was set to notBroadcasting, procedure 800 proceeds to operation 830. Otherwise, procedure 800 proceeds to operation 870.

At operation 830, if SIB1 is provided/supported (or currently being provided) on demand, procedure 800 proceeds to operation 840. Otherwise, procedure 800 proceeds to operation 860.

At operation 840, the UE sends a request for SIB1. Upon receiving the request, a gNB of the cell broadcasts all OSIs (all SI messages).

At operation 850, upon sending the request (or after receiving an ACK for the request), the UE acquires SIB1 and then acquires the other SI message(s)/SIBs from a broadcast transmission based on scheduling information in SIB1.

At operation 860, the UE acquires SIB1 when SIB1 is transmitted in the cell. The UE does not send a SIB1 request.

At operation 870, the UE checks the broadcast status bit in latest acquired SIB1. The UE sends a request for an SI message (or SIB other than SIB1) if the broadcast status bit for the SI message (or SIB other than SIB1) in the SIB1 is set to notBroadcasting. The UE acquires the SI message (or SIB other than SIB1) without sending an SI request if the broadcast status bit for the SI message in the SIB1 is set to Broadcasting.

Although FIG. 8 illustrates one example procedure 800 for acquiring an SI message, various changes may be made to FIG. 8. For example, while shown as a series of operations, various operations in FIG. 8 could overlap, occur in parallel, occur in a different order, occur any number of times, be omitted, or replaced by other operations.

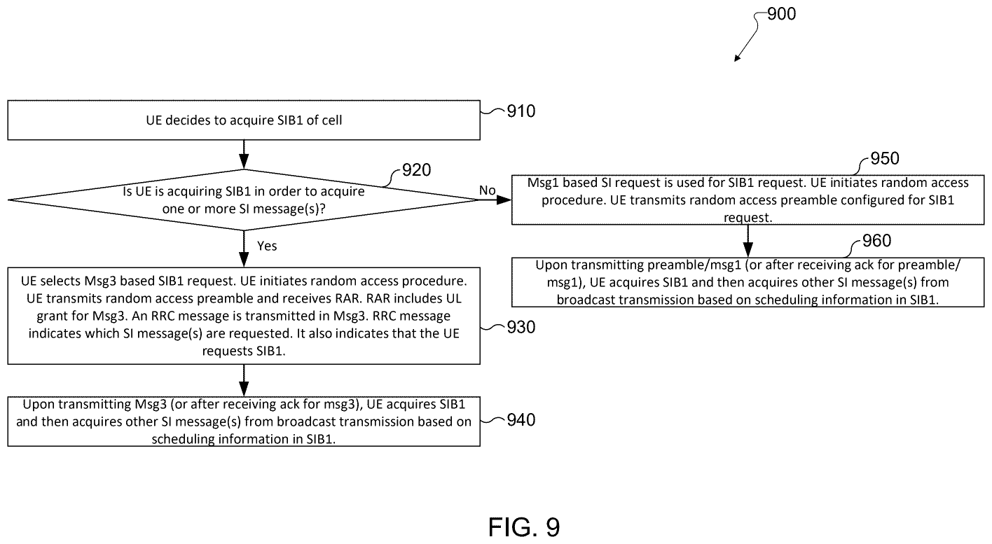

FIG. 9 illustrates another example procedure 900 for acquiring an SI message according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 9, procedure 900 begins at operation 910. At operation 910, a UE (such as UE 116 of FIG. 1) decides to acquire SIB1 of a cell. The UE sends a SIB1 request to a gNB of the cell to acquire SIB1 if SIB1 is provided on demand.

At operation 920, if the UE is acquiring SIB1 in order to acquire one or more SI message(s) (or SIBs other than SIB1), procedure 900 proceeds to operation 930. Otherwise, procedure 900 proceeds to operation 950.

At operation 930, the UE selects a Msg3 based SIB1 request. The UE initiates a random access procedure. The UE transmits a random access preamble and receives a RAR. The RAR includes a UL grant for a Msg3. An RRC message is transmitted in the Msg3. The RRC message indicates which SI message(s) (or SIBs other than SIB1) are requested by the UE to operate in the cell. The RRC message also indicates that the UE requests SIB1.

At operation 940, upon transmitting the Msg3 (or after receiving an ACK for the Msg3), the UE acquires SIB1 and then acquires other SI message(s) (or SIBs other than SIB1) from a broadcast transmission based on scheduling information in SIB1.

At operation 950, the UE uses a Msg1 based SI request to request SIB1. The UE initiates a random access procedure. The UE transmits a random access preamble configured for the SIB1 request.

At operation 960, upon transmitting the request (or after receiving an ACK for the request), the UE acquires SIB1 and then acquires other SI message(s) (or SIBs other than SIB1) from a broadcast transmission based on scheduling information in SIB1.

Although FIG. 9 illustrates one example procedure 900 for acquiring an SI message, various changes may be made to FIG. 9. For example, while shown as a series of operations, various operations in FIG. 9 could overlap, occur in parallel, occur in a different order, occur any number of times, be omitted, or replaced by other operations.

In some embodiments, a UE may decide to acquire SIB1 of cell, and the UE sends a SIB1 request to a gNB to acquire SIB1 if SIB1 is provided on demand. In these embodiments, the UE may initiate a random access procedure. The UE may transmit a random access preamble configured for the SIB1 request, and receive a RAR. The RAR may include an UL grant for a Msg3. If the UE decides to acquire one or more SI messages (or SIBs other than SIB1), an RRC message is transmitted in Msg3. The RRC message indicates which SI message(s) (or SIBs other than SIB1) are requested. Upon transmitting the Msg3 (or after receiving an ACK for the Msg3), The UE acquires SIB1 and then acquires other SI message(s) (or SIBs other than SIB1) from a broadcast transmission based on scheduling information in SIB1. Otherwise, the UE ignores the UL grant, terminates the random access procedure, and acquires SIB1.

In some embodiments, a UE may decide to acquire SIB1 of cell, and the UE sends a SIB1 request to a gNB to acquire SIB1 if SIB1 is provided on demand. In these embodiments, the UE may initiate a random access procedure. The may UE transmit a random access preamble configured for the SIB1 request. Upon transmitting the preamble, the UE may monitor a transmission period/window for monitoring a PDCCH addressed to an SI-RNTI for the SIB1. If the PDCCH is received (and the TB is successfully decoded), the UE can terminate the random access procedure or consider the random access procedure is successfully completed. If the PDCCH is not received (or the TB is not successfully decoded), the UE may retransmit the preamble configured for the SIB1 request. The transmission period/window may start at an offset from the end of the preamble transmission, or may start at the first PDCCH monitoring occasion for SIB1 after the end of the preamble transmission, or may start at the first PDCCH monitoring occasion for SIB1 which is at least offset away from the end of the preamble transmission. The offset can be fixed, zero or configured by the gNB in an RRC message or system information.

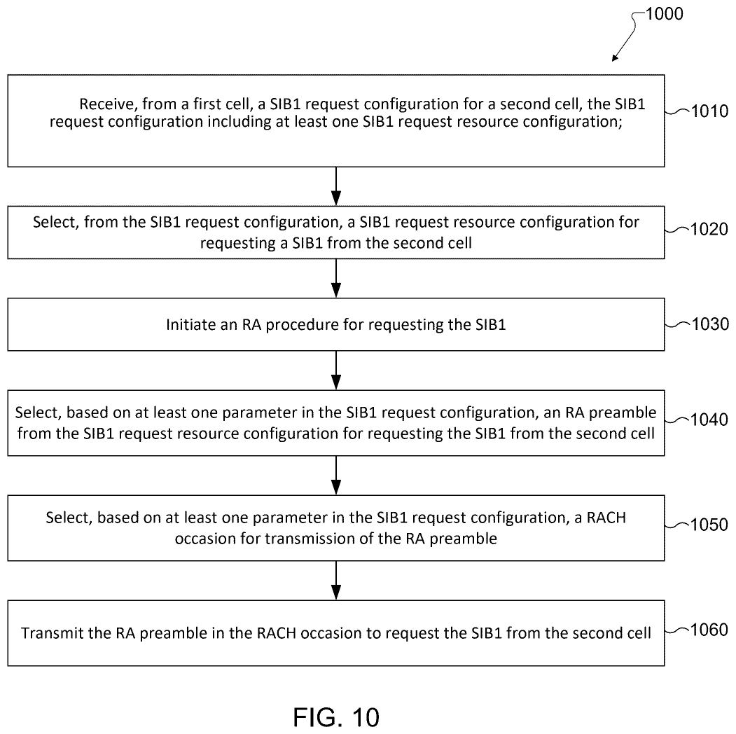

FIG. 10 illustrates an example method 1000 for a SIB1 request according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for a SIB1 request could be used without departing from the scope of this disclosure.

In the example of FIG. 10, method 1000 begins at step 1010. At step 1010 a UE (such as UE 116 of FIG. 1) receives, from a first cell, a SIB1 request configuration for a second cell. The SIB1 request configuration includes at least one SIB1 request resource configuration.

In some embodiments, the SIB1 request configuration may include one or more parameters absoluteFrequencyPointA, p-Max, prach-ConfigurationIndex, msg1-FDM, msg1-FrequencyStart, preambleReceivedTargetPower, preambleTransMax, powerRampingStep, ra-Response Window, ssb-PerRACH-Occasion, prach-RootSequenceIndex, prach-SubcarrierSpacing, n-TimingAdvanceOffset, and rsrp-ThresholdSSB.

In some embodiments, the SIB1 request resource configuration may include one or more parameters sib1-RequestPeriod, ra-PreambleStartIndex, ra-AssociationPeriodIndex, and ra-ssb-OccasionMaskIndex.

At step 1020, the UE selects, from the SIB1 request configuration, a SIB1 request resource configuration for requesting a SIB1 from the second cell.

In some embodiments, the SIB1 request configuration may include at least one of a SIB1 request resource configuration for an SUL and a SIB1 request resource configuration for an NUL, and the UE may select the SIB1 request resource configuration of the SUL or the SIB1 request resource configuration of the NUL for requesting the SIB1 from the second cell. When a SIB1 request resource configuration for an SUL of the second cell is available and an RSRP of a downlink pathloss reference of the second cell is less than rsrp-ThresholdSSB-SUL, the SIB1 request resource configuration for the SUL may be selected. When a SIB1 request resource configuration for an NUL of the second cell is available and the RSRP of the downlink pathloss reference of the second cell is greater than or equal to rsrp-ThresholdSSB-SUL, the SIB1 request resource configuration for the NUL may be selected.

In some embodiments, the SIB1 request configuration may include one or more SIB1 request resources for Msg1 repetitions, and the UE may select a SIB1 request resource from the one or more SIB1 request resources for Msg1 repetitions corresponding to a Msg1 repetition number when criteria to apply that Msg1 repetition number is met.

At step 1030, the UE initiates an RA procedure for requesting the SIB1.

Upon initiation of the RA procedure, at step 1040 the UE selects, based on at least one parameter in the SIB1 request configuration, an RA preamble from the SIB1 request resource configuration for requesting the SIB1 from the second cell. In some embodiments, to select the RA preamble, the UE may select an SSB from one or more SSBs of the second cell based on an rsrp-ThresholdSSB parameter in the SIB1 request configuration. In these embodiments, the selected RA preamble corresponds with the selected SSB.

At step 1050, the UE selects, based on at least one parameter in the SIB1 request configuration, a RACH occasion for transmission of the RA preamble.

At step 1060, the UE transmits the RA preamble in the RACH occasion to request the SIB1 from the second cell.

In some embodiments, in response to transmission of the RA preamble, the UE may monitor for a RAR corresponding with the RA preamble in monitoring occasions configured by a search space configuration in the SIB1 request configuration. The monitoring occasions may be monitored during a transmission window that occurs at an offset from an end of the transmission of the RA preamble.

In some embodiments, the UE may bar the second cell after a number of RA preamble transmissions indicated in the SIB1 request configuration without reception of an acknowledgement for the SIB1 request.

Although FIG. 10 illustrates one example method 1000 for a SIB1 request, various changes may be made to FIG. 10. For example, while shown as a series of steps, various steps in FIG. 10 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a first cell, a system information block 1 (SIB1) request configuration for a second cell, the SIB1 request configuration including at least one SIB1 request resource configuration; and
a processor operably coupled to the transceiver, the processor configured to:
select, from the SIB1 request configuration, a SIB1 request resource configuration for requesting a SIB1 from the second cell;
initiate a random access (RA) procedure for requesting the SIB1; and
upon initiation of the RA procedure:
select, based on at least one parameter in the SIB1 request configuration, an RA preamble from the SIB1 request resource configuration for requesting the SIB1 from the second cell;
select, based on at least one parameter in the SIB1 request configuration, an RA channel (RACH) occasion for transmission of the RA preamble; and
cause the transceiver to transmit the RA preamble in the RACH occasion to request the SIB1 from the second cell.

2. The UE of claim 1, wherein:
the SIB1 request configuration includes one or more parameters absoluteFrequencyPointA, p-Max, prach-ConfigurationIndex, msg1-FDM, msg1-FrequencyStart, preambleReceivedTargetPower, preambleTransMax, powerRampingStep, ra-ResponseWindow, ssb-PerRACH-Occasion, prach-RootSequenceIndex, n-prach-SubcarrierSpacing, TimingAdvanceOffset, and rsrp-ThresholdSSB; and
the SIB1 request resource configuration includes one or more parameters sib1-RequestPeriod, ra-PreambleStartIndex, ra-AssociationPeriodIndex, and ra-ssb-OccasionMaskIndex.

3. The UE of claim 1, wherein to select the RA preamble, the processor is further configured to select a synchronization signal block (SSB) from one or more SSBs of the second cell based on an rsrp-ThresholdSSB parameter in the SIB1 request configuration, and the selected RA preamble corresponds with the selected SSB.

4. The UE of claim 1, wherein:
the SIB1 request configuration includes at least one of a SIB1 request resource configuration for a supplementary uplink (SUL) and a SIB1 request resource configuration for a normal uplink (NUL); and
the processor is further configured to select the SIB1 request resource configuration of the SUL or the SIB1 request resource configuration of the NUL for requesting the SIB1 from the second cell,
wherein when a SIB1 request resource configuration for an SUL of the second cell is available and a reference signal received power (RSRP) of a downlink pathloss reference of the second cell is less than rsrp-ThresholdSSB-SUL, the SIB1 request resource configuration for the SUL is selected; and
when a SIB1 request resource configuration for an NUL of the second cell is available and the RSRP of the downlink pathloss reference of the second cell is greater than or equal to rsrp-ThresholdSSB-SUL, the SIB1 request resource configuration for the NUL is selected.

5. The UE of claim 1, wherein the processor is further configured to, after a number of RA preamble transmissions indicated in the SIB1 request configuration without reception of an acknowledgement for the SIB1 request, bar the second cell.

6. The UE of claim 1, wherein:
the transceiver is further configured to, in response to transmission of the RA preamble, monitor for an RA response (RAR) corresponding with the RA preamble in monitoring occasions configured by a search space configuration in the SIB1 request configuration; and
the monitoring occasions are monitored during a transmission window that occurs at an offset from an end of the transmission of the RA preamble.

7. The UE of claim 1, wherein:
the SIB1 request configuration includes one or more SIB1 request resources for message 1 (Msg1) repetitions; and
the processor is further configured to select a SIB1 request resource from the one or more SIB1 request resources for Msg1 repetitions corresponding to a Msg1 repetition number when criteria to apply that Msg1 repetition number is met.

8. A method of operating a user equipment (UE), the method comprising:
receiving, from a first cell, a system information block 1 (SIB1) request configuration for a second cell, the SIB1 request configuration including at least one SIB1 request resource configuration;
selecting, from the SIB1 request configuration, a SIB1 request resource configuration for requesting a SIB1 from the second cell;
initiating a random access (RA) procedure for requesting the SIB1; and
upon initiation of the RA procedure:
selecting, based on at least one parameter in the SIB1 request configuration, an RA preamble from the SIB1 request resource configuration for requesting the SIB1 from the second cell;
selecting, based on at least one parameter in the SIB1 request configuration, an RA channel (RACH) occasion for transmission of the RA preamble; and
transmitting the RA preamble in the RACH occasion to request the SIB1 from the second cell.

9. The method of claim 8, wherein:
the SIB1 request configuration includes one or more parameters absoluteFrequencyPointA, p-Max, prach-ConfigurationIndex, msg1-FDM, msg1-FrequencyStart, preambleReceivedTargetPower, preambleTransMax, powerRampingStep, ra-ResponseWindow, ssb-PerRACH-Occasion, prach-RootSequenceIndex, prach-SubcarrierSpacing, n-TimingAdvanceOffset, and rsrp-ThresholdSSB; and
the SIB1 request resource configuration includes one or more parameters sib1-RequestPeriod, ra-PreambleStartIndex, ra-AssociationPeriodIndex, and ra-ssb-OccasionMaskIndex.

10. The method of claim 8, wherein to select the RA preamble, the method further comprises selecting a synchronization signal block (SSB) from one or more SSBs of the second cell based on an rsrp-ThresholdSSB parameter in the SIB1 request configuration, and the selected RA preamble corresponds with the selected SSB.

11. The method of claim 8, wherein:
the SIB1 request configuration includes at least one of a SIB1 request resource configuration for a supplementary uplink (SUL) and a SIB1 request resource configuration for a normal uplink (NUL); and
the method further comprises selecting the SIB1 request resource configuration of the SUL or the SIB1 request resource configuration of the NUL for requesting the SIB1 from the second cell,
wherein when a SIB1 request resource configuration for an SUL of the second cell is available and a reference signal received power (RSRP) of a downlink pathloss reference of the second cell is less than rsrp-ThresholdSSB-SUL, the SIB1 request resource configuration for the SUL is selected; and
when a SIB1 request resource configuration for an NUL of the second cell is available and the RSRP of the downlink pathloss reference of the second cell is greater than or equal to rsrp-ThresholdSSB-SUL, the SIB1 request resource configuration for the NUL is selected.

12. The method of claim 8, further comprising, after a number of RA preamble transmissions indicated in the SIB1 request configuration without reception of an acknowledgement for the SIB1 request, barring the second cell.

13. The method of claim 8, further comprising, in response to transmission of the RA preamble, monitoring for an RA response (RAR) corresponding with the RA preamble in monitoring occasions configured by a search space configuration in the SIB1 request configuration,
wherein the monitoring occasions are monitored during a transmission window that occurs at an offset from an end of the transmission of the RA preamble.

14. The method of claim 8, wherein:
the SIB1 request configuration includes one or more SIB1 request resources for message 1 (Msg1) repetitions; and
the method further comprises selecting a SIB1 request resource from the one or more SIB1 request resources for Msg1 repetitions corresponding to a Msg1 repetition number when criteria to apply that Msg1 repetition number is met.

15. A non-transitory computer readable medium embodying a computer program comprising program code that, when executed by a processor of a device, causes the device to:
receive, from a first cell, a system information block 1 (SIB1) request configuration for a second cell, the SIB1 request configuration including at least one SIB1 request resource configuration;
select, from the SIB1 request configuration, a SIB1 request resource configuration for requesting a SIB1 from the second cell;
initiate a random access (RA) procedure for requesting the SIB1; and
upon initiation of the RA procedure:
select, based on at least one parameter in the SIB1 request configuration, an RA preamble from the SIB1 request resource configuration for requesting the SIB1 from the second cell;
select, based on at least one parameter in the SIB1 request configuration, an RA channel (RACH) occasion for transmission of the RA preamble; and
transmit the RA preamble in the RACH occasion to request the SIB1 from the second cell.

16. The non-transitory computer readable medium of claim 15, wherein:
the SIB1 request configuration includes one or more parameters absoluteFrequencyPointA, p-Max, prach-ConfigurationIndex, msg1-FDM, msg1-FrequencyStart, preambleReceivedTargetPower, preambleTransMax, powerRampingStep, ra-ResponseWindow, ssb-PerRACH-Occasion, prach-RootSequenceIndex, prach-SubcarrierSpacing, n-TimingAdvanceOffset, and rsrp-ThresholdSSB; and
the SIB1 request resource configuration includes one or more parameters sib1-RequestPeriod, ra-PreambleStartIndex, ra-AssociationPeriodIndex, and ra-ssb-OccasionMaskIndex.

17. The non-transitory computer readable medium of claim 15, wherein to select the RA preamble, the program code, when executed by the processor of a device, causes the device to select a synchronization signal block (SSB) from one or more SSBs of the second cell based on an rsrp-ThresholdSSB parameter in the SIB1 request configuration, and the selected RA preamble corresponds with the selected SSB.

18. The non-transitory computer readable medium of claim 15, wherein:
the SIB1 request configuration includes at least one of a SIB1 request resource configuration for a supplementary uplink (SUL) and a SIB1 request resource configuration for a normal uplink (NUL); and
the program code, when executed by the processor of the device, further causes the device to select the SIB1 request resource configuration of the SUL or the SIB1 request resource configuration of the NUL for requesting the SIB1 from the second cell,
wherein when a SIB1 request resource configuration for an SUL of the second cell is available and a reference signal received power (RSRP) of a downlink pathloss reference of the second cell is less than rsrp-ThresholdSSB-SUL, the SIB1 request resource configuration for the SUL is selected; and
when a SIB1 request resource configuration for an NUL of the second cell is available and the RSRP of the downlink pathloss reference of the second cell is greater than or equal to rsrp-ThresholdSSB-SUL, the SIB1 request resource configuration for the NUL is selected.

19. The non-transitory computer readable medium of claim 15, wherein the program code, when executed by the processor of a device, further causes the device to, after a number of RA preamble transmissions indicated in the SIB1 request configuration without reception of an acknowledgement for the SIB1 request, bar the second cell.

20. The non-transitory computer readable medium of claim 15, wherein the program code, when executed by a processor of a device, further causes the device to, in response to transmission of the RA preamble, monitor for an RA response (RAR) corresponding with the RA preamble in monitoring occasions configured by a search space configuration in the SIB1 request configuration,
wherein the monitoring occasions are monitored during a transmission window that occurs at an offset from an end of the transmission of the RA preamble.
